(19) United States
(12) Patent Application Publication
(10) Pub. No.: US 2007/0270018 A1
(43) Pub. Date: Nov. 22, 2007

(54) LOW PROFILE PUNCHING CONNECTOR

(75) Inventor: Marcio T. Alves, Campinas-SP, CEP: (BR)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/383,908

(22) Filed: May 17, 2006

(51) Int. Cl. H01R 4/24

(52) U.S. Cl. 439/404

(57) ABSTRACT

A connector interconnects a plurality of wires in an in-line splice. The connector generally includes an electrically insulating hollow body having an open side, a front wall and a rear wall, where each wall has at least one aperture. The connector generally further includes a cover mountable to the open side of the body. The cover has a plurality of piercing connectors located on its lower part that provide an electrical connection between the wires. The plurality of piercing connectors are connected by a conductive contact element.

### BACKGROUND

The present invention relates to solderless electrical splices or connections for low voltage wires. More particularly, the invention is a splice designed to provide a low profile, in-line configuration which can be quickly and safely applied.

Solderless devices for connecting electrical conductors and wires are known within the art. Common devices are adapted to provide a splice connection between two bare conductors. The connectors are generally made of a tapered ferrule seated within an insulated housing. Such connectors are adapted to be inserted over bare conductors that have been stripped of an outer insulating layer. The bare wires of two separate conductors are twisted to provide mechanical engagement between the two wires. The stripping process is achieved by a mechanism that is separate from the tool used to join the conductors together. The stripping process generally involves slotted metal plates having upstanding leg portions. Each of the slots is arranged to receive a conductor placed therein. The conductor is positioned perpendicular to the plane of the plate. Such devices require considerable care in use since the use of differently sized conductors in adjacent positions would cause undue deflection of the leg portions. The deflection causes a corresponding loss of electrical integrity between the plate and the conductor.

Subsequent devices have been designed to eliminate the stripping operation required to expose bare conductors. However, absent from the prior art is a universal low profile, in-line splice which may be simply and quickly installed on various sized wires. Typically, the body of the prior art devices are blocks or similar shapes. Leads are inserted in only one side, or on diagonally opposite sides, making in-line splicing difficult. In addition, cutting edges contained within these connectors are either rigidly mounted to the body, or the cutting edges are guided into place by openings in the body, making the connection difficult because of a lack of maneuverability. Also, prior art devices require the electrically connected conductors to be exposed and/or provide a cover that can be easily opened, both of which create safety hazards. Thus there is a need in the art for an improved low profile, in-line splice able to be safely and quickly installed.

### SUMMARY OF THE INVENTION

In one embodiment, the invention comprises a connector for interconnecting a plurality of wires in a solderless in-line splice. The connector includes an electrically insulating hollow body having an open side, a front wall and a rear wall, wherein each wall has at least one aperture. The connector further includes a cover mountable to the open side of the body. The cover has a plurality of piercing connectors located on its lower part, which provide an electrical connection between the wires. The plurality of piercing connectors are connected by a conductive contact element.

In another embodiment, the invention embodies an electrical connector for joining two low voltage insulated conductors. The connector has a main body portion with an outer wall which forms a conduit. The outer wall includes a plurality of slots and has an opening in the main body portion. The connector also has a cover portion having an inner surface and an outer surface. The cover incorporates a plurality of locking projections. A plurality of knife elements that are capable of piercing an insulated conductor are connected by a conductive strip and are part of the connector. The plurality of knife elements and conductive strip are secured to the cover, and the plurality of knife elements extend from the inner surface of the cover. The insertion of the locking projections of the cover into the plurality of slots of the main body portion creates a permanent connection between the cover and main body portion to complete the connector.

In yet another embodiment, the invention comprises an electrical connector for joining two insulated conductors. The connecter includes a conduit with a first end and a second end, an open area, and at least one engagement aperture. The connector also includes a cover portion that completes the conduit when installed. The cover portion has at least one locking projection mateable with the engagement aperture. A plurality of knife elements connected by a conductive strip of material are attached to the cover. The conduit allows for the in-line insertion of insulated conductors into the first end and the second end.

### BRIEF DESCRIPTION OF THE DRAWINGS

FIG. 1 is a perspective view of a low profile electrical connector according to one embodiment of the invention.

FIG. 2A is a plan view of the low profile connector of FIG. 1.

FIG. 2B is a side elevation view of the low profile connector of FIG. 1.

FIG. 2C is front elevation view of the low profile connector of FIG. 1.

FIG. 3A is a front elevation view of two wires joined by a low profile connector according to one embodiment of the invention.

FIG. 3B is a cross sectional view of the wires and connector depicted in FIG. 3A illustrating two wires joined by a low profile connector.

FIG. 4 is a cross-sectional view of a low profile connector according to one embodiment of the invention.

FIGS. 5A and 5B illustrate several different piercing connector geometries according to multiple embodiments of the invention.

FIG. 6A illustrates several different geometries for attachment tabs according to multiple embodiments of the invention.

FIG. 6B illustrates two tabs engaging different apertures.

FIG. 7 is a perspective view of an angled low profile connector according to one embodiment of the invention.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale.

### DETAILED DESCRIPTION OF PREFERRED EMBODIMENTS

The present invention allows for the solderless in-line splicing of low voltage electrical cables with a low profile electrical connector. The present invention is further explained with reference to the drawing figures, wherein like structures are referred to by like numbers throughout the several views.

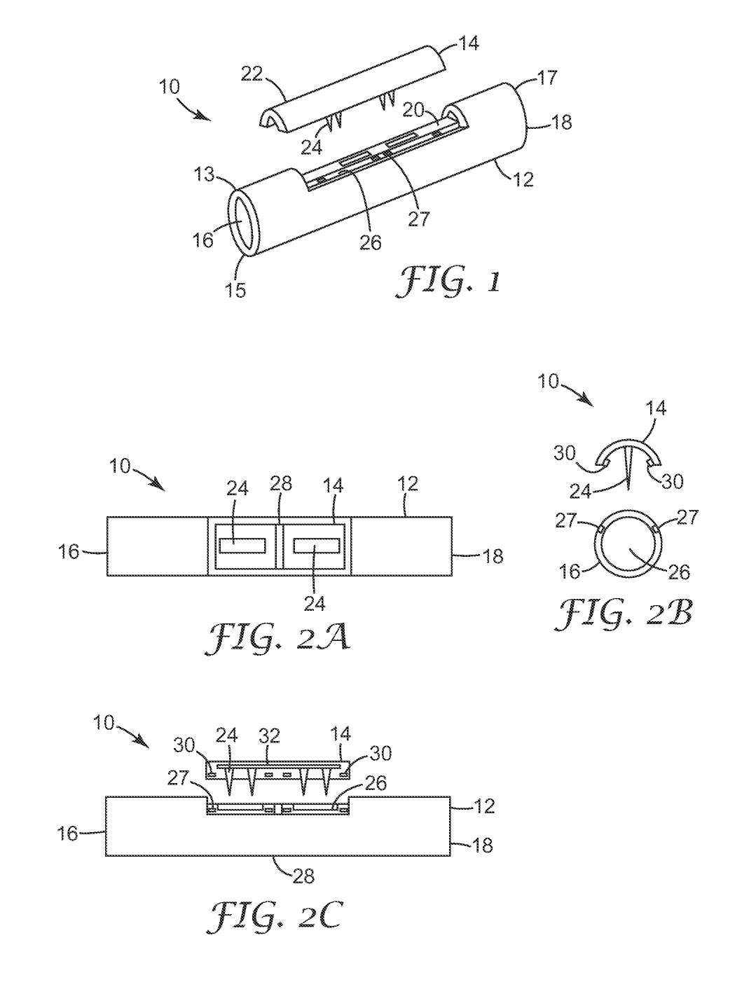

FIG. 1 is a perspective view of a low profile electrical connector 10. Illustrated in FIG. 1 is connector 10, which includes main body portion 12 and cover 14. Main body 12 is a conduit formed of outer wall 13, and includes first end 16 with first end wall 15, second end 18 with second end wall 17, and cover aperture 20. Main body 12 is illustrated as generally cylindrical in shape to be used with round wires or cables, but the shape may be adapted to match the type of wires to be used. First end 16 and second end 18 are constructed to receive low voltage electrical conductors, which may be wires or cables. Connector 10 also includes cover 14 having body portion 22 and knife elements 24. Body portion 22 of cover 14 is constructed to mate with main body portion 12 and includes projections for attaching thereto (not visible in this view). When cover 14 is installed, knife elements 24 extend into hollow cavity portion 26 of main body portion 12. Main body portion 12 also has several apertures 27, the purpose of which will be later detailed.

Both body portion 22 of cover 14 and main body 12 are fabricated from suitable plastic material such as polyethylene and polypropylene. In one embodiment, the plastic material used to manufacture connector 10 contains or is coated with a flame retardant material. The material of main body 12 and cover 14 also acts as an electrical insulator. Main body 12 and cover 14 may be manufactured using a process such as injection molding.

FIG. 2A is a plan view of connector 10 shown in FIG. 1. In this view, connector 10 includes main body 12, which has first end 16 and second end 18, as well as central divider 28. Central divider 28 acts to inhibit the progression through connector 10 of a wire inserted into either end 16 or 18, thus preventing the wire from being pushed entirely through the connector. Divider 28 also acts to limit how far a wire can be inserted into the connector. Divider 28 will also prevent a wire inserted into first end 16 from directly contacting a wire inserted into second end 18, which can prevent shocks or sparks during installation of connector 10. In an exemplary embodiment, divider 28 is centrally located.

Also shown in FIG. 2A is cover 14. In this embodiment, at least a portion of cover 14 is made of a transparent or semi-transparent material to create an inspection window therein. This allows a user to see the position of the conductors as well as knife elements 24 within connector 10.

Knife elements 24 are blades or similar piercing structures or connectors which are made a conductive material. Knife elements 24 may be manufactured as part of cover 14, or attached to cover 14 after manufacturing the cover. Each cover 14 will generally include a plurality of knife elements 24 that are welded together or formed as a single unit to ensure conductivity therethrough. Knife elements 24 pierce the insulating jacket of a conductor to complete an electrical splice. Knife elements 24 in cover 14 provide the electrical connection between two adjacent wires within the connector 10. Each individual knife element 24 pierces and contacts a separate conductor. Knife elements 24 are electrically connected, and thus provide electrical continuity between the individual pierced conductors.

Knife elements 24, in the specific embodiment illustrated in FIGS. 1 and 2A, are generally U-shaped. Each cover 14 illustrated contains two U-shaped knife elements 24 that are in electrical contact with one another. The U-shaped knife element 24 contains two generally parallel leg portions, with each leg portion being generally perpendicular to a connecting strip. Each leg of the U-shaped knife element 24 comes to a point that is capable of piercing an insulating jacket of a conductor. Each U-shaped knife element 24 pierces a separate electrical conductor inserted into the opposite sides of main body 12 at opposing first end 16 and second end 18. The U-shape of the knife element 24 aids in assuring an adequate connection in a small, enclosed space. For example, if one leg of knife element 24 fails to penetrate the insulating jacket of a conductor and instead bends, the second leg is still able to pierce the insulating jacket of the conductor.

Knife elements 24 may be composed of copper or aluminum, or combinations and alloys thereof, and may be coated with tin or other noble metals to prevent galvanic corrosion. Alternatively, knife elements 24 may be composed of any noble metal. In an exemplary embodiment, knife elements 24 are cylindrical. In this embodiment, knife elements 24 may be of the same diameter as the conductor to allow improved piercing of the insulating jacket of a conductor.

FIG. 2B is a side elevation view of connector 10. Main body 12 is shown as a hollow cylindrical tube, and cover 14 is a portion of the tube which will mate with main body 12 to complete the tube once inserted to complete the connector 10. Main body 12 has attachment apertures 27. Attachment apertures 27 are openings, holes or slots which allow for the engagement of attachment tabs 30. Attachment tabs 30 are extensions or projections connected to cover 14 used to secure cover 14 to main body portion 12.

FIG. 2C is a front elevation view of main body 12 and a cross sectional view of cover 14. In this view, cover 14 includes knife elements 24 which are connected by conducting strip 32. Conducting strip 32 provides electrical continuity between knife elements 24. In the embodiment illustrated, conducting strip 32 is a flat piece of conductive metal constructed from the same material as knife elements 24. In alternate embodiments, conducting strip 32 may be constructed from any conductive material, including a conductive adhesive. Thus, when each knife element 24 pierces a separate conductor, the separate conductors become electrically connected. Attachment tabs 30 are visible on the inner surface of cover 14. Attachment tabs 30 are high relief projections molded as part of cover 14. After conductors have been inserted into first end 16 and second end 18, cover 14 is pressed downward to attach to main body 12, completing a cylinder of connector 10. Attachment tabs 30 lock with apertures 27 preventing removal of cover 14 from main body 12.

In the embodiment shown, knife elements 24 and conducting strip 32 are manufactured as a single piece. In other embodiments, knife elements 24 may be manufactured separate from conducting strip 32 and secured thereto. Knife elements 24 may be adjoined to conducting strip 32 of cover 14, for example, through insert injection molding, welding processes, through the use of adhesives, or by any similar manufacturing process known within the art. In an exemplary embodiment, knife elements 24 and conductive strip 32 are connected to cover 14 by means of conductive adhesives during or after an injection molding process. As cover 14 is installed, knife elements 24 will pierce the insulating jacket of conductors and create a contact with the metal interior of the conductor.

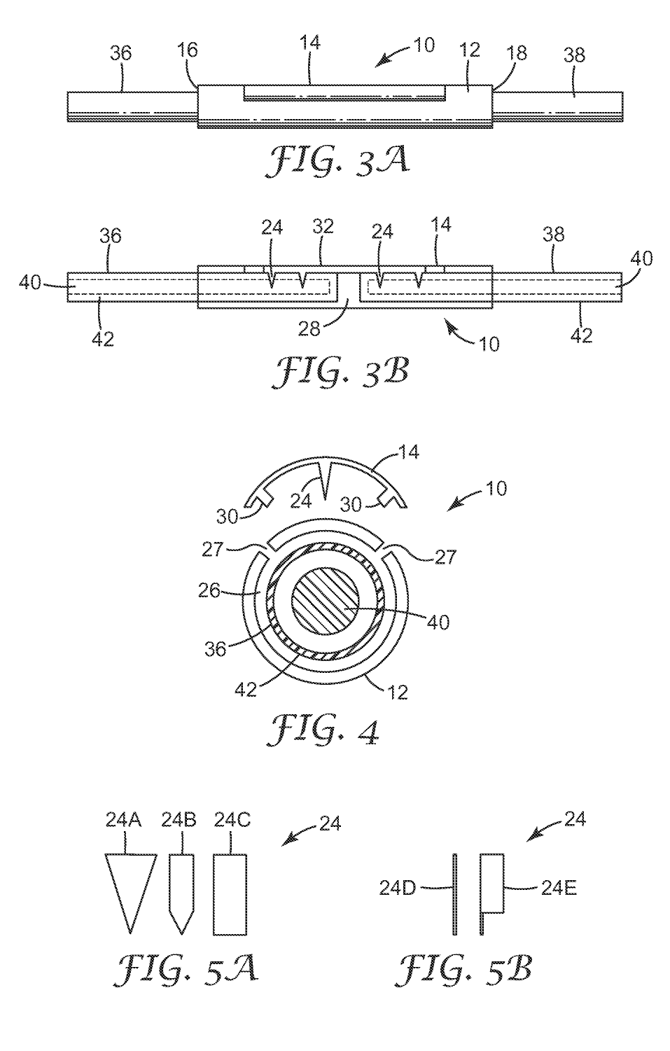

FIG. 3A is a front elevation view of a connector 10 having conductors 36 and 38 inserted therein. In FIG. 3A, first conductor 36 has been inserted into the first end 16 of main body portion 12 of connector 10, while a second conductor 38 has been inserted into second end 18. Cover 14 has been secured to the main body portion 12. The connection provides a low profile, in-line splice that is not much larger in volume than that of either conductor 36 or 38.

FIG. 3B is a cross-section view of connector 10 with conductors 36 and 38 inserted. In FIG. 3B, first and second conductors 36 and 38 each have metal portion 40 and insulated jacket 42. The conductors 36 and 38 have been inserted into connector 10 until each respective conductor 36 and 38 has come into contact with divider 28. Cover 14 has been inserted such that knife elements 24 pierce insulating jacket 42 of conductors 36 and 38. Thus, the metal portion 40 of each conductor 36 and 38 is in contact with the knife elements 24 which are connected by conducting strip 32 creating conductive attachment between them.

In one embodiment, conductors 36 and 38 are low voltage wires or cables. Although conductors 36 and 38 are illustrated as having insulating jackets 42, insulating jackets 42 may be removed prior to inserting conductors 46 and 38 into connector 10. However, it is often preferable that insulating jackets 42 are left intact. The intact insulating jacket 42 acts to provide stabilization for the wires within the connector, and also to protect the user against electrical shocks when handling conductors 36 and 38.

FIG. 4 is a cross-sectional view of connector 10. Illustrated are main body portion 12 with attachment apertures 27, cover 14 having knife elements 24 and attachment tabs 30, as well as conductor 36, which has metal portion 40 and insulating jacket 42. A user will push down on cover 14 which will cause the knife element 24 to pierce the insulating jacket 42 of conductor 36 and contact the conductive wire of metal portion 40. Simultaneously, attachment tabs 30 will enter engagement apertures 27 to hold the cover 14 in place. In alternative embodiments, the engagement apertures may be included within the cover and the main body portion may include attachment tabs.

Also visible in FIG. 4 is hollow cavity portion 26. The ratio of the inner cross sectional area to the outer cross-sectional area is preferably minimized, and each gage of cable or wire may have its own appropriately sized connector. For example, for an inner cavity cross sectional area of 0.5 mm² to 1.5 mm², the preferred ratio of the outer perimeter of the connector to the outer perimeter of the cable will generally be about 1.3. In another embodiment, the inner cross sectional area is in the range of 1.5 mm² to 4 mm² and the ratio of the outer perimeter of the connector to the outer perimeter of the cable will generally be about 1.2. Overall, the ratio of the outer perimeter of the connector to the outer perimeter of the cable is preferably in the range of about 1.2 to about 1.5. In both of the embodiments discussed above, the connector generally will have a length not exceeding about 40 mm and preferably greater than about 10 mm. Similarly, connectors for any size cable should generally not have a main body wall thickness greater than about 2 mm, and the wall thickness will range from about 0.8 mm to about 2 mm depending on the gage of the conductor to be inserted into the connector.

Hollow cavity 26 may optionally contain silicon gel or a similar composition to protect the electrical connection contained within it from moisture, dust, and other contaminants. Similarly, main body portion 12 may have one or more penetrable or rupturable membranes that cover the first end 16 and second end 18 adjacent first end wall and second end wall, respectively, to prevent contaminants from entering the assembled connector 10.

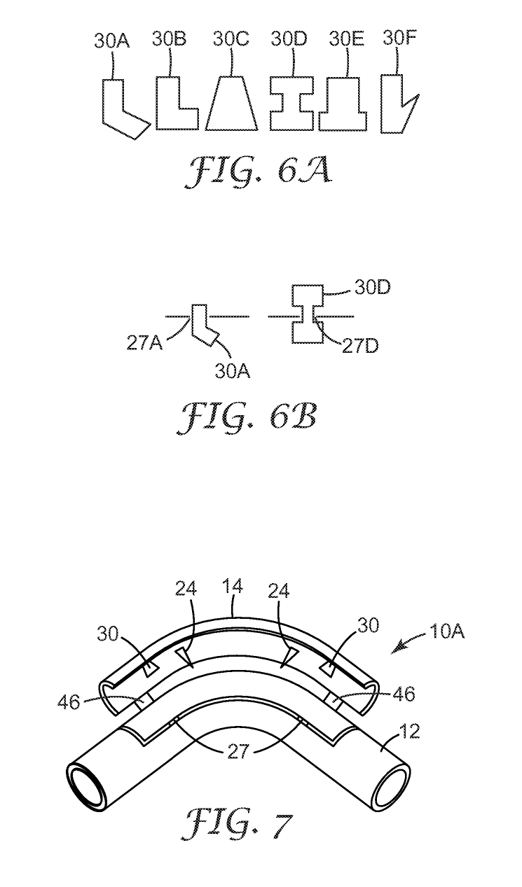

FIG. 5A and FIG. 5B illustrate several different geometries of knife elements. In FIG. 5A, knife element 24A is generally conical in shape. Knife element 24B incorporates a conical tip, but has a cylindrical body portion much like the tip of a pencil. Knife element 24C is a rectangular blade. Any of the geometries may be used as one of the legs for a u-shaped knife element as previously described. Knife element 24C may be a flat, thin knife element having a sharp lower edge, as represented by 24D of FIG. 5B. Alternatively, knife element 24C may have a thin knife element blade portion connected to the rectangular body as represented by 24E. Any geometry of knife element will work provided that the knife element will penetrate conductors inserted into the connector.

FIG. 6A illustrates several different geometries for attachment tabs 30 that act as high relief projections to secure the cover 14 with respect to main body portion 12 of connector 10. Tabs 30 may be larger on the base and include a necked portion for insertion into apertures 27. Tabs 30 are flexible enough to allow the slightly enlarged areas or necked portions to be inserted into the corresponding engagement apertures 27. For example, tab 30A is an angle projection, while tab 30B is an L-shaped projection. Tab 30C is trapezoidal in shape. Tab 30D is I-shaped, and tab 30E is T-shaped, but rotated 180 degrees. Tab 30F is a rectangle that has a transverse hook portion. In all embodiments illustrated, tabs 30A-30F are connected to cover 14 adjacent the top portion of each tab 30A-30F. Tabs 30 may be integrally molded as part of cover 14 (see FIG. 4), or may be manufactured separately and secured to cover 14 through adhesives or a fabricating process such as ultrasonic welding. In an exemplary embodiment, attachment tabs 30 are constructed from the same material as cover 14.

FIG. 6B illustrates tabs 30A and 30D within apertures 27A and 27D, respectively. Tab 30A is an angle projection that is inserted into aperture 27A. Tab 30A is used on one side of cover 14, while a mirror image tab would be used on the opposite side of cover 14. Thus, once cover 14 has been located in place, tabs 30 will enter apertures 27. Tabs 30 are flexible enough to allow for insertion into apertures 27. The opposing angles of the embodiment illustrated can prevent the cover from being removed without compromising the integrity of tabs 30A and cover 14. In an alternate embodiment, tab 30D attached to cover 14 is inserted into aperture 27D. Again, once the connector has been assembled, the cover can not be removed without compromising the integrity of the tab 30D. Tabs 30 may have different geometries, however, it is generally preferable that the geometries of tabs 30 result in a permanently locked connector once tabs 30 have been engaged in apertures 27. As such, a cable inserted and locked into connector 10 may not be removed unless cover 14 has been stripped and rendered unusable. When cover 14 is locked into place, knife elements 24 will pierce the cable and penetrate insulating jacket 42 to keep the cable fixed in place (See FIG. 3B).

FIG. 7 is a perspective view of an angled low profile in-line connector 10A. Connector 10A again has main body portion 12 that includes apertures 27, and cover 14 with knife elements 24 and attached tabs 30. Connector 10A also includes hinges 46. Knife elements 24, apertures 27, and tabs 30 are the same structures as previously described. Hinges 46 couple cover 14 to main body portion 12, and may be constructed from the same or similar material as main body portion 12 of connector 10A. With hinges 46, the user need not handle two pieces when trying to install the connector, but need only to flip cover 14 over and lock it in place once cables or wires have been inserted into connector 10A.

Connector 10A still allows for in-line and solderless splicing of cables. Similarly, connector 10A is low profile. The angle of connector 10A can be varied depending upon the specific requirements of a desired application. This embodiment allows for a low profile stiffening of a cable at a splice at a required angle. For example, connector 10A may be used to prevent a kink in a cable or wire running along a corner without substantially adding to the area required to run the cable.

One advantage of a low profile, in-line splice is that it may be placed in areas where there is little room for more than the wires alone. The in-line connectors of the present invention allow for the splicing of cables and wires without substantially adding to the volume of the cable itself. The generally cylindrical shape of the connector allows the connector to be placed anywhere along the cable with minimal intrusion into the surrounding area, especially for cables in tight places such as inside a conduit. The low profile, in-line splice also has the advantage for providing a neat and unintrusive appearance in exposed wiring. The connector has the appearance of an extension of the conductors rather than a connection.

Further, because the knife elements are conductively connected in the cover, no stripping of cables is required prior to insertion of the connector. Thus, an ordinary lay person is capable of using the connector. No extra tools are required for installation as the cover snaps into place through pressure applied by squeezing the cover and main body together.

Although the present invention has been described with reference to several embodiments, those of ordinary skill in the art will recognize that changes may be made in form and detail without departing from the spirit and scope of the invention.

1. A connector for interconnecting a plurality of wires comprising:
an electrically insulating hollow body having an open side, a front wall and a rear wall, the front wall and rear wall each having at least one aperture;
a cover mountable to the open side of the body;
a plurality of piercing connectors located on an inside portion of the cover; and
a contact element capable of conductively connecting the plurality of piercing connectors;
wherein each of the plurality of piercing connectors pierces a conductor of each of the plurality of wires to provide electrical continuity between the plurality of wires and wherein the piercing connectors have a conical shape.

2. (canceled)

3. The connector of claim 1 wherein the cover is secured through a projection that engages in slots of the body.

4. The connector of claim 3 wherein the cover is removably attached to the body.

5. The connector of claim 3 wherein the cover is attached to the body through a hinge type connection.

6. The connector of claim 1 wherein the cover comprises an inspection window.

7. The connector of claim 1 wherein two apertures are arranged in a linear manner to provide connection of wires in a straight line splice.

8. An electrical connector for joining two insulated conductors comprising:
a conduit comprising a first end and a second end, the conduit containing an open area and at least one engagement aperture;
a cover portion sized to mate with the open area and which completes the conduit when the cover portion is closed, wherein the cover portion comprises at least one locking projection mateable with the at least one of the engagement apertures; and
a plurality of knife elements connected by a conductive strip of material connected to the cover portion, wherein at least one of the plurality of knife elements pierces an insulating jacket and pierces a conductive portion of one of the insulated conductors when the cover is closed and wherein the knife elements have a conical shape.

9. The electrical connector of claim 8 further comprising a dividing wall within the conduit.

10. The electrical connector of claim 8 wherein the dividing wall is centrally located.

11. The electrical connector of claim 8 wherein the cover is coupled to the conduit by a hinge.

12. The connector of claim 8 wherein the cover comprises an inspection window.

13. The electrical connector of claim 8 wherein the overall length of the connector is less than about 40 mm.

14. The electrical connector of claim 8 wherein the ratio of the conduit outer perimeter to the outer perimeter of one of the conductors is between about 1.2 to about 1.5.

15. An electrical connector for joining two insulated conductors, the connector comprising:
a main body portion comprising an outer wall to form a conduit, the outer wall containing a plurality of slots;
at least one opening in the main body portion;
a cover portion containing an inner surface and an outer surface, wherein the cover contains a plurality of locking projections; and
a plurality of knife elements connected by a conductive strip, the knife elements being capable of piercing both an insulative portion and a conductive portion of an insulated conductor, wherein the plurality of knife elements and conductive strip are secured to cover and the plurality of knife elements extend from the inner surface, and wherein the knife elements have a conical shape;
wherein the insertion of the locking projections of the cover into the plurality of slots of the main body portion creates a connection between the cover and the main body portion.

16. The electrical connector of claim 15 wherein the cover is coupled to the conduit by a hinge.

17. The electrical connector of claim 15 wherein the connector contains a first end and a second end, wherein the first end is not in a direct line contact with the second end.

18. The electrical connector of claim 17 wherein the connector is a 90° elbow.

19. The electrical connector of claim 15 wherein at least one of the knife elements is generally U-shaped and contains two legs, wherein each leg contains a pointed tip for piercing the insulated conductor.

20. The electrical connector of claim 15 wherein the cover comprises an inspection window.
